(19) United States
(12) Patent Application Publication
(10) Pub. No.: US 2024/0300600 A1
(43) Pub. Date: Sep. 12, 2024

(54) Motorcycle Floor Mat And Motorcycle

(71) Applicant: DARWIN PRECISIONS CORPORATION, Hsinchu County (TW)

(72) Inventors: TZU-HSUAN PENG, Hsinchu County (TW); CHIA HSIN CHANG, Hsinchu County (TW); Hsiu-Chen Sun, Hsinchu County (TW)

(21) Appl. No.: 18/207,693

(22) Filed: Jun. 9, 2023

(30) Foreign Application Priority Data
Mar. 8, 2023 (TW) 112108526

(51) Int. Cl. B62J 7/02; B62J 25/04; B62K 11/02

(52) U.S. Cl. CPC B62J 7/02; B62J 25/04; B62K 11/02

(57) ABSTRACT

The present invention provides a motorcycle floor mat including a base and a folding bracket. The base is adapted to be placed on a foot pedal and has a receiving groove. The folding bracket is pivotally connected to the receiving groove and adapted to be raised from the receiving groove. The present invention further provides a motorcycle including the above folding bracket.

### CROSS-REFERENCE TO RELATED APPLICATION

This application claims the priority benefit of Taiwan Application No. 112108526, filed on Mar. 8, 2023. The entirety of the above-mentioned patent application is hereby incorporated by reference herein and made a part of this specification.

### FIELD OF THE INVENTION

The present invention relates to a motorcycle floor mat and a motorcycle, and more particularly to a motorcycle floor mat and a motorcycle with a folding bracket.

### BACKGROUND OF THE INVENTION

In Taiwan, it is quite popular for people to use motorcycles for commuting or daily transportation. However, due to a limited carrying space of a motorcycle, if a rear compartment of the motorcycle cannot meet the requirement for carrying an item, the carried item will be placed on a foot pedal of the motorcycle instead. During riding of the motorcycle, there is a risk for the carried item to fall off the foot pedal of the motorcycle. When the carried item falls off, in addition to possible damage of the carried item, it is more likely to cause a traffic accident, so it is necessary to take precautions.

### SUMMARY OF THE INVENTION

The present invention provides a motorcycle floor mat, which is adapted to be placed on a foot pedal of a motorcycle, to prevent a carried item from falling.

The present invention further provides a motorcycle to prevent the carried item from falling.

The motorcycle floor mat provided by the present invention includes a base and a folding bracket. The base is adapted to be placed on a foot pedal and has a receiving groove. The folding bracket is pivotally connected to the receiving groove and adapted to be raised from the receiving groove.

In an embodiment of the present invention, the above base has a first surface and a second surface opposite to each other, the second surface is adapted to be connected to the foot pedal, the receiving groove is arranged on the first surface, and when the folding bracket is received in the receiving groove, the folding bracket does not protrude from the first surface.

In an embodiment of the present invention, the above base further has a gripping recess arranged on the first surface and adjacent to the receiving groove.

In an embodiment of the present invention, a pivot direction of the folding bracket is a direction from a front of the motorcycle to a rear of the motorcycle.

In an embodiment of the present invention, the above folding bracket is pivotally connected to an inner wall of the receiving groove.

In an embodiment of the present invention, the above motorcycle floor mat further includes a support member pivotally connected to the folding bracket and the inner wall of the receiving groove.

In an embodiment of the present invention, the above folding bracket has a first end and a second end opposite to each other, the first end is pivotally connected to the inner wall of the receiving groove, the support member includes a first support section and a second support section, the first support section has a third end and a fourth end opposite to each other, the second support section has a fifth end and a sixth end opposite to each other, the third end is pivotally connected to the second end, the fourth end is pivotally connected to the fifth end, the sixth end is pivotally connected to the inner wall of the receiving groove, and the sixth end and the first end are pivotally connected to two opposite sides of the receiving groove.

In an embodiment of the present invention, the above base further has a slide rail arranged in the receiving groove, and the folding bracket is pivotally connected to the slide rail and adapted to move along the slide rail.

In an embodiment of the present invention, the above base further has multiple limit structures arranged on the slide rail and adapted to limit a position of the folding bracket on the slide rail.

The motorcycle further provided by the present invention includes a housing and a folding bracket, wherein the housing includes a foot pedal, the foot pedal has a receiving groove, and the folding bracket is pivotally connected to the receiving groove and adapted to be raised from the receiving groove.

The motorcycle floor mat and the motorcycle according to the present invention have the folding bracket, so that when the carried item is placed on the foot pedal of the motorcycle, the folding bracket may be raised to prevent the item from falling, and when there is no need to carry the item, the folding bracket may be folded to avoid occupying a foot placement space for a rider.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram that a motorcycle floor mat is placed on a motorcycle according to an embodiment of the present invention;

FIG. 2 is a schematic diagram that a folding bracket is raised from a receiving groove according to an embodiment of the present invention;

FIG. 3 is a schematic diagram that a folding bracket is received in a receiving groove according to an embodiment of the present invention;

FIG. 4A and FIG. 4B are schematic diagrams of a folding bracket in different raised states according to another embodiment of the present invention;

FIG. 5 is a schematic diagram that a folding bracket moves in a receiving groove according to another embodiment of the present invention;

FIG. 6 is a schematic diagram that a folding bracket moves in a receiving groove according to another embodiment of the present invention;

FIG. 7 is a schematic sectional view of a motorcycle floor mat according to another embodiment of the present invention; and

FIG. 8 is a schematic diagram of a motorcycle according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The above and other technical contents, features and effects of the present invention will be clearly presented in the detailed description of a preferred embodiment below in conjunction with the reference drawings. The directional term mentioned in the embodiment below, such as up, down, left, right, front, or back, is only the direction with reference to the accompanying drawings. Therefore, the directional terms used are used to explain rather than to limit the present invention.

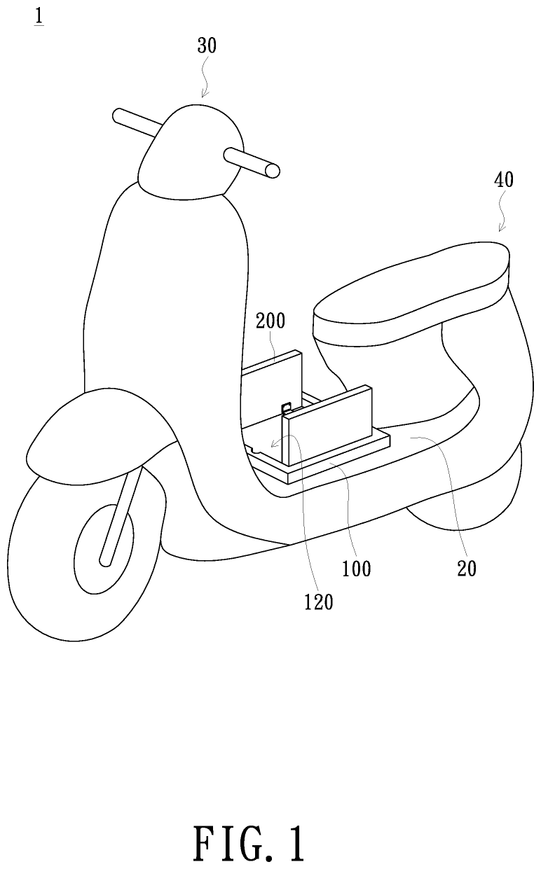

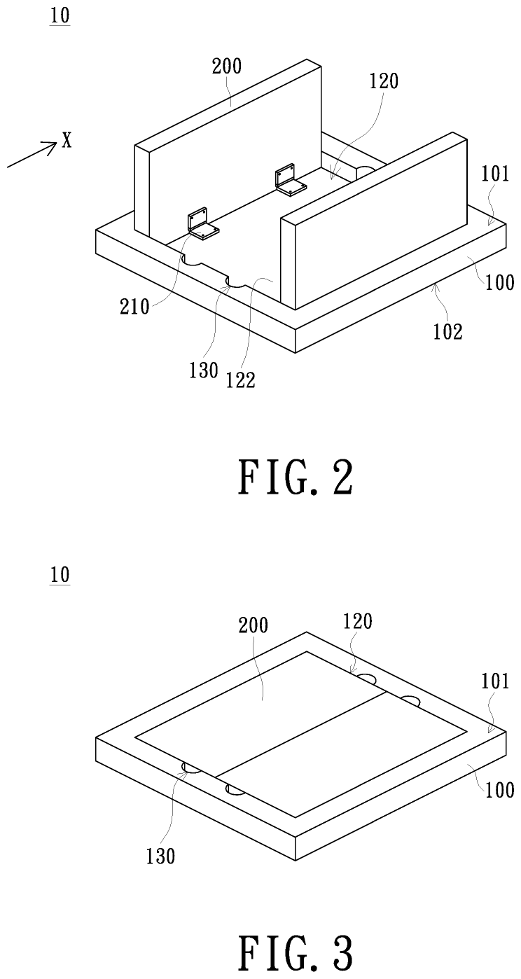

FIG. 1 is a schematic diagram that a motorcycle floor mat is placed on a motorcycle according to an embodiment of the present invention, FIG. 2 is a schematic diagram that a folding bracket is raised from a receiving groove according to an embodiment of the present invention, and FIG. 3 is a schematic diagram that a folding bracket is received in a receiving groove according to an embodiment of the present invention. Referring to FIG. 1 and FIG. 2 first, a motorcycle floor mat 10 in this embodiment includes a base 100 and a folding bracket 200. The base 100 is adapted to be placed on the foot pedal 20 and has a receiving groove 120. The folding bracket 200 is pivotally connected to the receiving groove 120, for example, the folding bracket is pivotally connected to an inner wall 122 of the receiving groove 120, and the folding bracket is adapted to be raised from the receiving groove 120, wherein a pivot direction X of the folding bracket 200 is, for example, a direction from a front 30 of a motorcycle 1 to a rear 40 of the motorcycle. The base 100 has, for example, a first surface 101 and a second surface 102 opposite to each other, the second surface 102 is adapted to be connected to the foot pedal 20, and the receiving groove 120 is, for example, arranged on the first surface 101.

Specifically, the motorcycle floor mat 10 in this embodiment includes, for example, two folding brackets 200 arranged in the receiving groove 120, and each folding bracket 200 is, for example, pivotally connected to the inner wall 122 (such as a bottom wall) of the receiving groove 120 via two pivotal connection pieces 210. The two folding brackets 200 of the motorcycle floor mat 10 are, for example, arranged on two opposite sides of the receiving groove 120, so that a receiving space between the two folding brackets 200 may be expanded after the folding brackets 200 are raised. The number of folding brackets 200 in this embodiment is, for example, two, but is not specifically limited in the present invention. In addition, the types, arrangement positions, and number of pivotal connection pieces 210 in FIG. 1 are only examples. In another embodiment of the present invention, the pivotal connection piece may also be a pivot that passes through the folding bracket and has two ends pivotally connected to an inner wall (such as a side wall) of the receiving groove, respectively. The prevent invention is not limited thereto.

Referring to FIG. 2 and FIG. 3, the base 100 further has, for example, a gripping recess 130 arranged on the first surface 101 and adjacent to the receiving groove 120. Through the design of the gripping recess 130, it is easy for a rider to grip the folding bracket 200 via the gripping recess 130 when the folding bracket 200 is received in the receiving groove 120. Specifically, the base 100 in this embodiment is, for example, provided with two gripping recesses 130 on two opposite sides of the receiving groove 120, respectively. However, the number and arrangement positions of gripping recesses 130 are not specifically limited in the present invention. In another embodiment, the base 100 does not have, for example, the gripping recess 130.

In addition, when the folding bracket 200 in this embodiment is received in the receiving groove 120, the folding bracket 200 does not, for example, protrude from the first surface 101, which facilitates the rider to put the feet flat on a motorcycle floor mat 10 when the rider has no requirement for carrying an item and the folding bracket 200 is folded. However, the present invention is not limited thereto. In another embodiment of the present invention, the folding bracket may also be slightly higher than the first surface when received in the receiving groove.

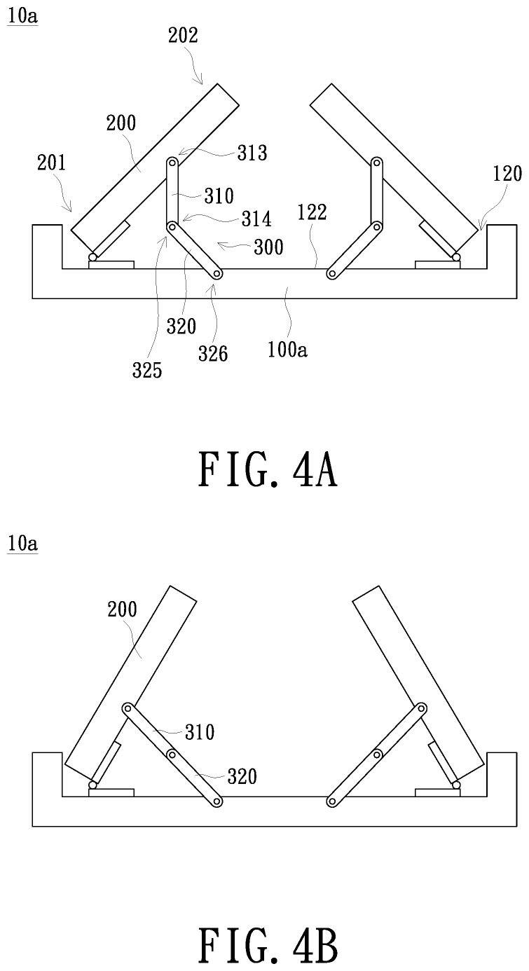

FIG. 4A and FIG. 4B are schematic diagrams of a folding bracket in different raised states according to another embodiment of the present invention. Referring to FIG. 4A first, a motorcycle floor mat 10a in this embodiment is similar to the motorcycle floor mat 10 in FIG. 2, and there is a main difference that the motorcycle floor mat 10a further includes, for example, two support members 300 each pivoted to the corresponding folding bracket 200 and the inner wall 122 of the receiving groove 120. Each folding bracket 200 has, for example, a first end 201 and a second end 202 opposite to each other, and the first end 201 is, for example, pivotally connected to the inner wall 122 of the receiving groove 120. The support member 300 includes, for example, a first support section 310 and a second support section 320, the first support section 310 has, for example, a third end 313 and a fourth end 314 opposite to each other, the second support section 320 has, for example, a fifth end 325 and a sixth end 326 opposite to each other, the third end 313 is, for example, pivotally connected to the second end 202, the fourth end 314 is, for example, pivotally connected to the fifth end 325, the sixth end 326 is, for example, pivotally connected to the inner wall 122 of the receiving groove 120, and the sixth end 326 and the first end 201 are, for example, pivotally connected to two opposite sides of the receiving groove 120. The requirement for one support member 300 to be pivotally connected to one folding bracket 200 is not specifically limited in the present invention. In another embodiment, two support members 300 may be both pivotally connected to one folding bracket 200.

Next, referring to FIG. 4A and FIG. 4B, in this embodiment, the folding brackets 200 may be adjusted in angle according to the usage requirement by using, for example, the support members 300. For example, the support member 300 in FIG. 4A and FIG. 4B in this embodiment has a total of two support sections, a first support section 310 and a second support section 320, so that the corresponding folding bracket 200 may be fixed at different angles via the two support sections. Although the support member 300 in this embodiment includes two support sections, the present invention is not limited thereto. In other embodiments of the present invention, the support member has, for example, only one support section or three or more support sections.

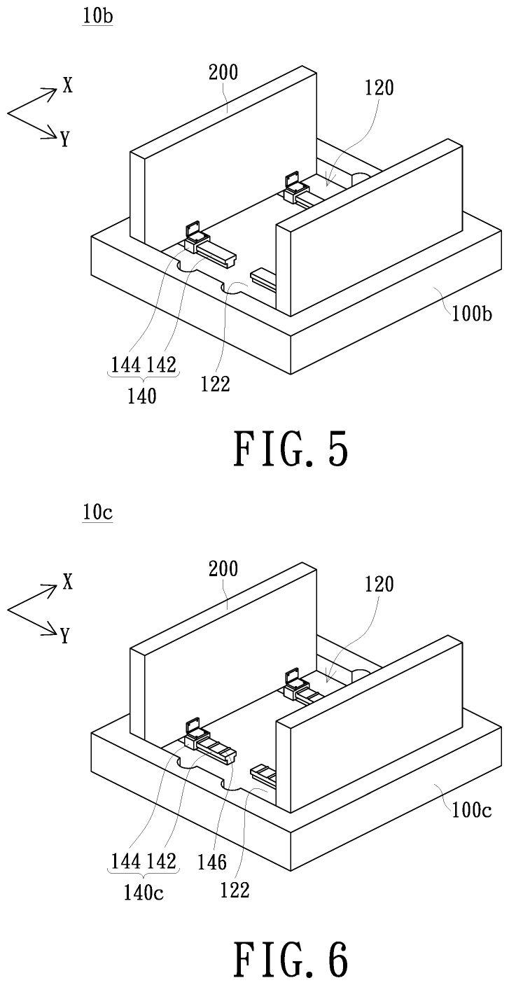

FIG. 5 is a schematic diagram that a folding bracket moves in a receiving groove according to another embodiment of the present invention. Referring to FIG. 5, compared with FIG. 2, a base 100b in this embodiment further has, for example, a slide rail 140 arranged in the receiving groove 120. The folding bracket 200 is, for example, pivotally connected to the slide rail 140 and adapted to move along the slide rail 140. Specifically, a motorcycle floor mat 10b has, for example, two folding brackets 200, wherein after the folding brackets 200 are raised, two opposite sides of one end, close to the receiving groove 120, of the folding bracket 200 are, for example, pivotally connected to two slide rails 140, respectively; each slide rail 140 has, for example, a track 142 and a slide seat 144; the slide seat 144 is arranged on the track 142, and the track 142 is arranged on the inner wall 122 (such as the bottom wall) of the receiving groove 120; in other words, the slide rails 140 in this embodiment are convex rails protruding from the receiving groove 120. The arrangement of the slide rails 140 may allow the folding brackets 200 to move in the receiving groove 120, which enables the rider to adjust positions of the folding brackets 200 according to the size requirement of the carried item, so as to adjust a distance between the folding brackets 200. Although each folding bracket 200 in this embodiment is, for example, pivotally connected to two slide rails 140, and one slide rail 140 has, for example, one track 142 and one slide seat 144, the present invention is not limited thereto. Furthermore, a track direction Y of the slide rail 140 in this embodiment is, for example, perpendicular to the pivot direction X. In addition, one folding bracket 200 is adapted to be folded towards one side facing the other folding bracket 200, and when the folding brackets 200 are adapted to be raised, the two slide seats 144 pivotally connected to the two folding brackets 200, respectively, in the track direction Y are located at two ends away from each other in the receiving groove 120. When the folding brackets 200 are raised, the folding brackets 200 pivotally connected to the slide seats 144 may move along the tracks 142. In other words, by folding one folding bracket 200 towards one side facing the other folding bracket 200, it may be ensured that the folding brackets 200 can be received in the receiving groove 120 during storage. However, one side, adapted to be folded, of the folding bracket 200 and a position of the slide seat 144 in the receiving groove 120 when the folding bracket 200 is adapted to be folded are not specifically limited in the present invention.

FIG. 6 is a schematic diagram that a folding bracket moves in a receiving groove according to another embodiment of the present invention. Referring to FIG. 6, compared with the base 100b in FIG. 5, a base 100c of a motorcycle floor mat 10c in this embodiment further has, for example, multiple limit structures 146 arranged on a slide rail 140c and adapted to limit a position of the folding bracket 200 on the slide rail 140c, wherein each limit structure 146 is, for example, a bulge, and three limit structures 146 are, for example, arranged on one track 142. Therefore, when the rider moves the folding bracket 200 to a predetermined position, the limit structures 146 may limit the position of the slide seat 144 within a predetermined range, such as between the two adjacent limit structures 146, to limit the position of the folding bracket 200, thereby avoiding the discomfort and traffic danger of the rider that are caused by collision with the feet of the rider and change in center of gravity of a motorcycle due to random movement of the folding bracket 200 on the slide rail 140c. The number of limit structures 146 and the requirement for the limit structures 146 to be bulge structures are not specifically limited in the present invention. In another embodiment, the limit structures 146 may be grooves.

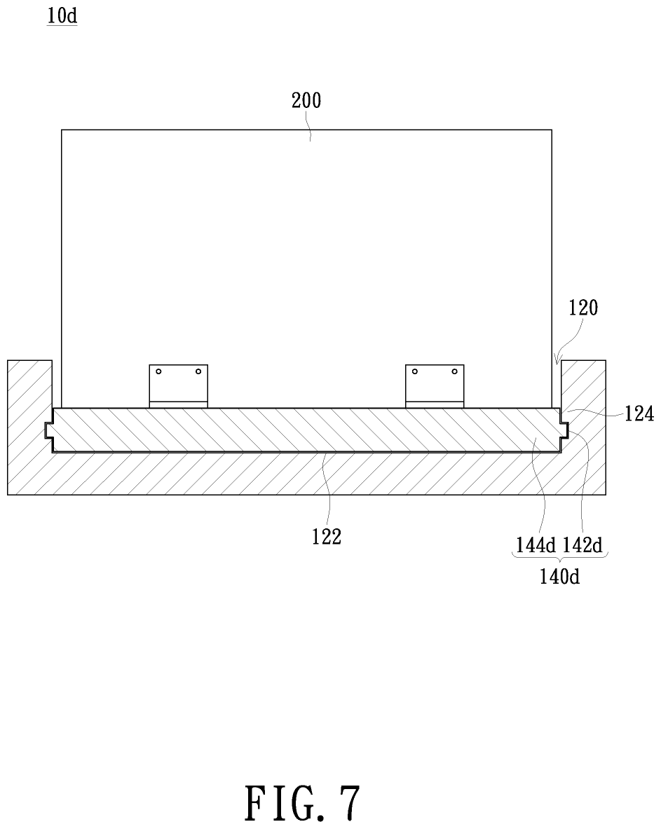

FIG. 7 is a schematic sectional view of a motorcycle floor mat according to another embodiment of the present invention. Referring to FIG. 7, a slide rail 140d of a motorcycle floor mat 10d in this embodiment is similar to the slide rail 140 in FIG. 5, but the track 142 of the slide rail 140 is the convex rail arranged on the inner wall 122 (such as the bottom wall) of the receiving groove 120, while in this embodiment, a groove adapted to place a track 142d is provided on the inner wall 124 (such as the side wall) of the receiving groove 120, and one folding bracket 200 is pivotally connected to one slide seat 144d. In other words, the slide rail 140d in this embodiment are a concave rail, but the present invention is not limited thereto.

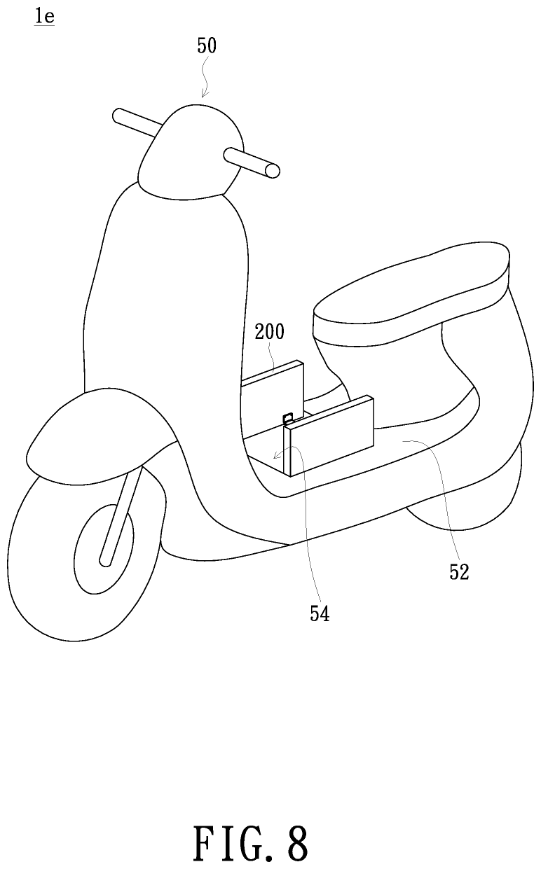

FIG. 8 is a schematic diagram of a motorcycle according to another embodiment of the present invention. Referring to FIG. 8, a motorcycle 1e in this embodiment includes a housing 50 and a folding bracket 200, wherein the housing 50 includes a foot pedal 52, the foot pedal 52 has a receiving groove 54, and the folding bracket 200 is pivotally connected to the receiving groove 54 and adapted to be raised from the receiving groove 54. A difference between the motorcycle 1e in this embodiment and the motorcycle 1 in FIG. 1 is that the folding bracket 200 of the motorcycle 1e in this embodiment is directly arranged in the receiving groove 54 of the foot pedal 52. However, the motorcycle floor mat 10 with the folding bracket 200 is additionally arranged on the foot pedal 20 of the motorcycle 1 in FIG. 1. Furthermore, it should be specially noted that the housing 50 in this embodiment may include the above gripping recess 130, slide rail 140, 140c, or 140d, and limit structures 146 in other embodiments of the present invention. In addition, the motorcycle 1e in this embodiment may also include the support member 300 in the above embodiment, and the specific content will not be repeated.

In summary, the motorcycle floor mat and the motorcycle according to the present invention have the folding bracket, so that when the carried item is placed on the foot pedal of the motorcycle, the folding bracket may be raised to prevent the item from falling, and when there is no need to carry the item, the folding bracket may be received in the receiving groove of the base to avoid occupying a foot placement space for the rider.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A motorcycle floor mat, adapted to be placed on a foot pedal of a motorcycle, the motorcycle floor mat comprising:
a base, adapted to be placed on the foot pedal and having a receiving groove; and
a folding bracket, pivotally connected to the receiving groove and adapted to be raised from the receiving groove.

2. The motorcycle floor mat according to claim 1, wherein the base has a first surface and a second surface opposite to each other, the second surface is adapted to be connected to the foot pedal, the receiving groove is arranged on the first surface, and when the folding bracket is received in the receiving groove, the folding bracket does not protrude from the first surface.

3. The motorcycle floor mat according to claim 2, wherein the base further has a gripping recess arranged on the first surface and adjacent to the receiving groove.

4. The motorcycle floor mat according to claim 1, wherein a pivot direction of the folding bracket is a direction from a front of the motorcycle to a rear of the motorcycle.

5. The motorcycle floor mat according to claim 1, wherein the folding bracket is pivotally connected to an inner wall of the receiving groove.

6. The motorcycle floor mat according to claim 5, further comprising a support member pivotally connected to the folding bracket and the inner wall of the receiving groove.

7. The motorcycle floor mat according to claim 6, wherein the folding bracket has a first end and a second end opposite to each other, the first end is pivotally connected to the inner wall of the receiving groove, the support member comprises a first support section and a second support section, the first support section has a third end and a fourth end opposite to each other, the second support section has a fifth end and a sixth end opposite to each other, the third end is pivotally connected to the second end, the fourth end is pivotally connected to the fifth end, the sixth end is pivotally connected to the inner wall of the receiving groove, and the sixth end and the first end are pivotally connected to two opposite sides of the receiving groove.

8. The motorcycle floor mat according to claim 1, wherein the base further has a slide rail arranged in the receiving groove, and the folding bracket is pivotally connected to the slide rail and adapted to move along the slide rail.

9. The motorcycle floor mat according to claim 8, wherein the base further has multiple limit structures arranged on the slide rail and adapted to limit a position of the folding bracket on the slide rail.

10. A motorcycle, comprising a housing and a folding bracket, wherein the housing comprises a foot pedal, the foot pedal has a receiving groove, and the folding bracket is pivotally connected to the receiving groove and adapted to be raised from the receiving groove.
